(19) United States
(12) Patent Application Publication
(10) Pub. No.: US 2020/0051101 A1
(43) Pub. Date: Feb. 13, 2020

(54) Systems and Methods for Margin Rate Optimization

(71) Applicant: Leslie Nicole Purcell, Carrollton, TX (US)

(72) Inventor: Leslie Nicole Purcell, Carrollton, TX (US)

(21) Appl. No.: 16/450,749

(22) Filed: Jun. 24, 2019

Related U.S. Application Data
(60) Provisional application No. 62/689,189, filed on Jun. 24, 2018.

(51) Int. Cl. G06Q 30/02

(52) U.S. Cl. CPC G06Q 30/0206; G06Q 30/0201

(57) ABSTRACT

The present invention provides systems and methods for margin rate optimization, especially within an online purchasing environment. The present invention identifies and utilizes a customer's “propensity to purchase” a product or service of a particular type, and then structures a specific “customer experience” for the individual that maximizes margins for the goods and services and for the modes of product delivery. Rather than focusing on maximizing revenue, the present invention uses historical data in indexed databases, portfolios of various proven customer purchasing experiences, along with correlation algorithms, to maximize margin rates across a businesses' range of products and services.

### CROSS REFERENCES TO RELATED APPLICATIONS

This application claims the benefit under Title 35 United States Code § 119(e) of U.S. Provisional Patent Application Ser. No. 62/689,189; Filed: Jun. 24, 2018; the full disclosure of which is incorporated herein by reference.

### BACKGROUND OF THE INVENTION

### 1. Field of the Invention

The present invention relates generally to systems and methods for marketing narrowly customized customer experiences in a purchasing transaction. The present invention relates more specifically to systems and methods that allow a business to optimize margin rates in the process of offering customized and accurately targeted and delivered customer experiences.

### 2. Description of the Related Art

Businesses that offer a variety of customer experiences to their prospective customers are often at a loss as to how to best market a particular type of purchasing experience to a particular type of customer. With consumer purchasing transactions occurring more frequently online, businesses are positioned to provide an ever-wider array of individualized “customer experiences.” As used in this detailed description, “customer experience” describes every encounter between a business and a customer or potential customer. From ad placement (positioned to be encountered by a specific customer) to product delivery, and finally to repeat purchasing, the “customer experience” describes every manner and timing of interactions or potential interactions between the business and the consumer.

The “purchasing decision” made by a consumer is as different and individual as there are distinct and individual persons making the decision. Businesses have in the past been required to direct their advertising to attract customers in a “least common denominator” approach, offering and providing a single customer experience that was at best calculated to reach and sell the product or service to the largest number of customers. With the advent of digital media and advertising, businesses have been able to more easily target advertising to particular customers or customer types. More recently, businesses, especially those delivering products or services online, are increasingly able to not only customize the promotional side of the sale, but also to customize the delivery of the goods and services after the sale. Unfortunately, mechanisms and methods for optimizing revenue, or more specifically for optimizing margins, within this environment of targeted advertising and customized products and services, are severely lacking.

Some efforts have been made to improve the process of targeting certain consumers or consumer types based upon their propensity to purchase a certain type or quantity of a product or service. Such efforts, however, have generally been little more than the typical process of offering an array of products or services and “guessing” as to what type of customer might be interested in which particular product or service in the product line. Large amounts of advertising dollars are still being spent on customers that will never purchase the particular product or service that is being offered.

It would be desirable to have a system and method for the delivery of a variety of customer experiences that would allow businesses to better optimize their profit margins. It would be desirable if such a system and method could be based upon more accurate metrics and could implement more accurate predictors of the type of customer experience an individual customer would prefer. It would be desirable if such a system and method could be dynamic with respect to both the databases used to maintain historical trends and the algorithms used to correlate the information from the various databases within the system. It would be desirable if such a system and method would allow a business to optimize its advertising resources and its product delivery costs, to most efficiently and effectively bring its goods and services to consumers.

### SUMMARY OF THE INVENTION

In fulfillment of the above and other objectives, the present invention provides systems and methods for margin rate optimization, especially within an online purchasing environment. Going well beyond simple targeted advertising, the present invention identifies and utilizes a customer's or potential customer's “propensity to purchase” a product or service of a particular type, and then structures a specific “customer experience” for the individual that maximizes margins for those goods and services. Rather than focusing on maximizing revenue (a process that tends to ignore customer satisfaction, repeat business, and the dynamic nature of the online world), the present invention maximizes margin rates. In the end, margin rate optimization, coupled with sound short and long term product strategies, will do more to maximize revenue over time than methods that focus primarily on the pricing of the product or service in isolation from the customer experience.

### BRIEF DESCRIPTION OF THE DRAWINGS

FIG. 1 is a high-level flowchart showing the broad base methodologies implemented by the systems and methods of the present invention.

FIG. 2 is a schematic block diagram showing the basic progression of the methodologies of the present invention.

FIG. 3 is a more detailed flowchart of the methodology broadly identified as Process A in the high-level flowchart shown in FIG. 1.

FIG. 4 is a more detailed flowchart of the methodology broadly identified as Process B in the high-level flowchart shown in FIG. 1.

FIG. 5 is a more detailed flowchart of the methodology broadly identified as Process C in the high-level flowchart shown in FIG. 1.

FIG. 6 is a high level diagram showing the overall system architecture for carrying out the methodology shown in FIG. 1.

### DETAILED DESCRIPTION OF THE PREFERRED EMBODIMENTS

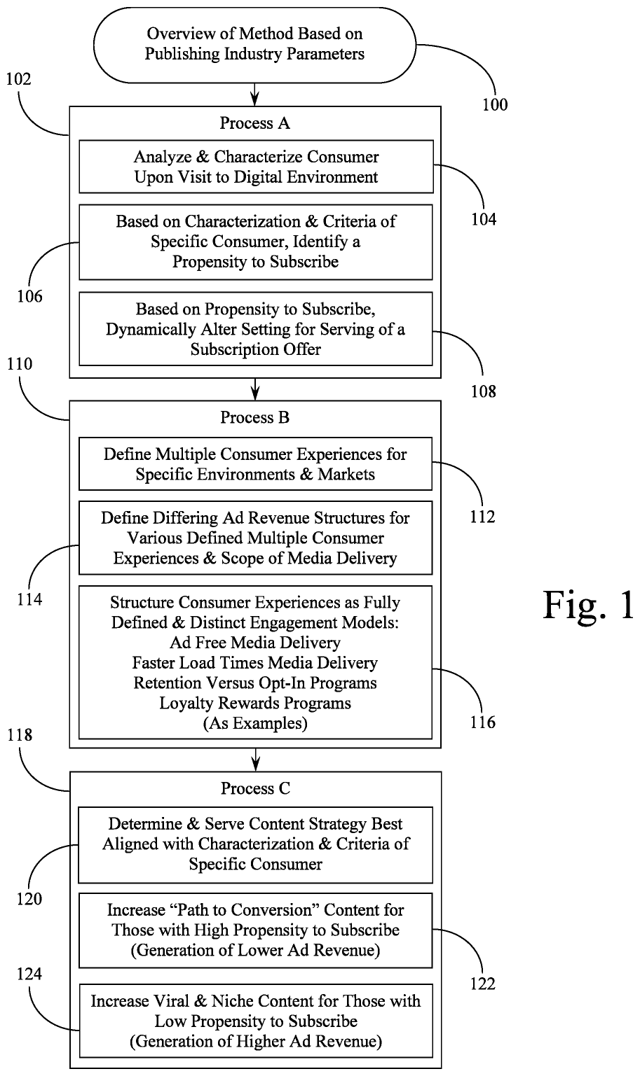

The present invention provides systems and methods that allow a business to optimize margin rates in the process of offering customized and accurately targeted customer purchasing experiences and product delivery experiences. Reference is made first to FIG. 1 which is a high-level flowchart showing the broad base methodologies implemented by the systems and methods of the present invention. The overall method, initiated at Step 100, implements three general processes identified as A, B & C in FIG. 1. Process A, shown generally as Step 102, focusses on the consumer. Process B, shown generally as Step 110, focusses on the consumer experience (the product or service and its mode of delivery). Process C, shown generally as Step 118, focusses on the dynamic process of delivering the most appropriate consumer experience.

As indicated in FIG. 1, the example provided in this detailed description involves the publishing industry, although those skilled in the art will recognize that any industry where variations in the consumer experience are possible can benefit from the application of the described methods. Examples of other such industries include, without limitation, non-profits or charitable organizations, transportation service industries, food and household product delivery services, entertainment services, etc. The methods of the present invention lend themselves in particular to any business that might offer its products and services alternately on a onetime basis or on a subscription basis. Likewise, businesses that are capable of delivering their products and services electronically (fully or partially) and customizing the manner and timing of such delivery, are also likely to benefit from the use of the systems and method of the present invention.

Process A, shown generally as Step 102 in FIG. 1, involves building the historical customer database and organizing it for correlation to the various consumer experiences (Process B). Step 104 involves analyzing and characterizing consumers upon “visits” to digital environments. Based on the characterization of the consumer and other criteria associated with the consumer's visit to the contact environment, the process identifies, at Step 106, a propensity to subscribe. In the example shown in FIG. 1, related to the publishing industry, delivery of product to the consumer can take the form of a onetime purchase, a purchase of a set number of delivered products, or a limited or unlimited subscription service. Once again, the publishing industry is described as but one example of the application of the systems and methods of the present invention. Based on the propensity to subscribe, established at Step 106, the process may proceed at Step 108 to dynamically alter the internal setting for the serving of a subscription offer.

Process B, shown generally as Step 110 in FIG. 1, involves building the consumer experience database that is to be correlated with the consumer database. This process begins at Step 112 by simply defining the various multiple consumer experiences the business is capable of providing, based upon the goods and services of the business, and the specific business environments and markets. In some businesses, such as the publishing industry, there are revenue streams that can be an alternative to the revenue generated by the sale of the primary product. In the publishing industry this alternate revenue stream is commonly the publication of paid advertising (unassociated with the advertising of the publishing business itself). Step 114 in FIG. 1 provides for defining different ad revenue structures for various defined multiple consumer experiences with reference to the scope (quantity and/or duration) of the media delivered. Analogous alternative revenue streams are common in other industries as well. Defining the appropriate consumer experience (optimized margin rate) can involve striking the appropriate balance between direct product revenue streams and alternate revenue streams such as advertising in the publishing industry. The present invention factors in all potential revenue streams in optimizing margin rates. Process B shown in FIG. 1 at Step 116, endeavors to structure each specific consumer experience as a fully defined and distinct customer engagement model. Examples of these (specific to the publishing industry) include ad-free media delivery, faster load times media delivery, retention versus opt-in programs, loyalty rewards programs, etc.

Process C shown in FIG. 1 generally as Step 118 then brings the two compiled databases together by correlating the specific consumer with a specific consumer experience. Step 120 therefore involves determining and serving the content strategy (in the publishing industry example) best aligned with the established characterization and criteria of the specific consumer. In some industries this might be the end of the process but in many industries the dynamic aspects of the product delivery stage of the process lead to ongoing modification of the consumer characterization and ongoing development of an evolving consumer experience. In the publishing industry, this might be seen at Step 122 where the consumer experience benefits from an effort to increase (over time) “path to conversion” content for those consumers with a high propensity to subscribe (coinciding with the generation of lower ad revenues in most cases). Step 124 involves an opposing dynamic where there might be an increase in viral or niche content for those with a low propensity to subscribe (coinciding with the generation of higher ad revenue based on click through delivery of content for example).

Those skilled in the art will recognize that there is less of an order to the processes described than there is a coordinated development of the databases and of the dynamic algorithms that drive the correlation between the information in the consumer characterization database and the consumer experience portfolio database. Therefore, the order of steps shown in FIG. 1 is less relevant than the fact that Processes A & B will generally occur prior to Process C.

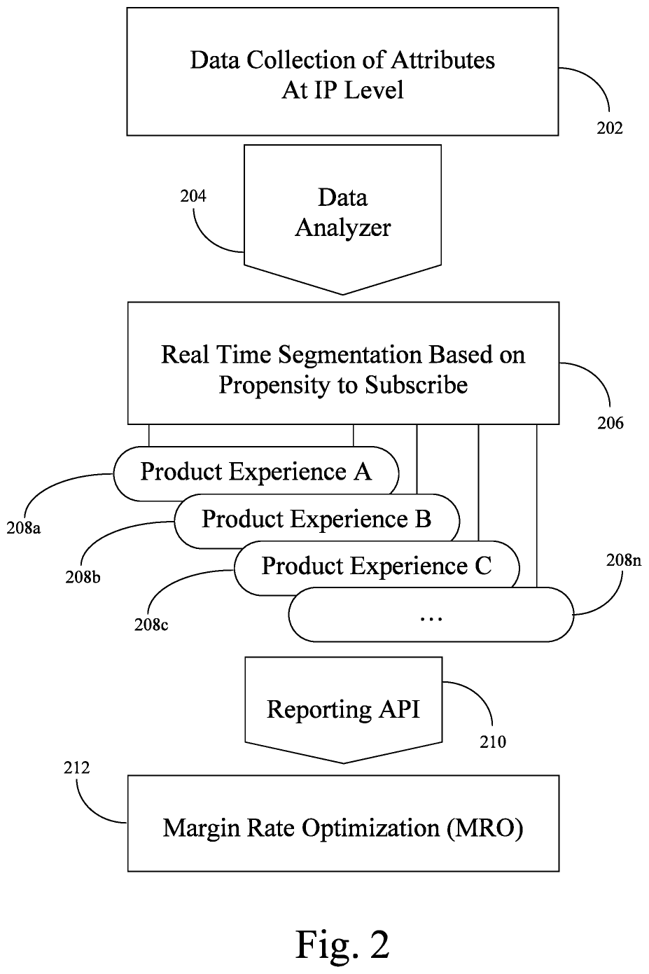

Reference is next made to FIG. 2 which is a system architecture diagram showing the basic progression of the methodologies of the present invention. Step 202 is defined by the data collection of attributes at the IP level which is required before the methodologies can begin to correlate consumers with purchase experiences. Step 204 broadly represents the process of data analysis which leads to the general designation of consumer characteristics at Step 206 wherein the real time segmentation based on propensity to subscribe (again specific to the publishing industry) occurs. Following from process Step 206, the range of product (consumer) experiences designated as Steps 208a-208n are selected. After this primary selection and serving of the consumer experience is made the process of reporting out the application programming interface for the system and method may occur at Step 210. The result of this dynamic reporting and analysis is a true margin rate optimization (MRO) that provides the business with a clear picture of the revenue stream, despite its potential complexity.

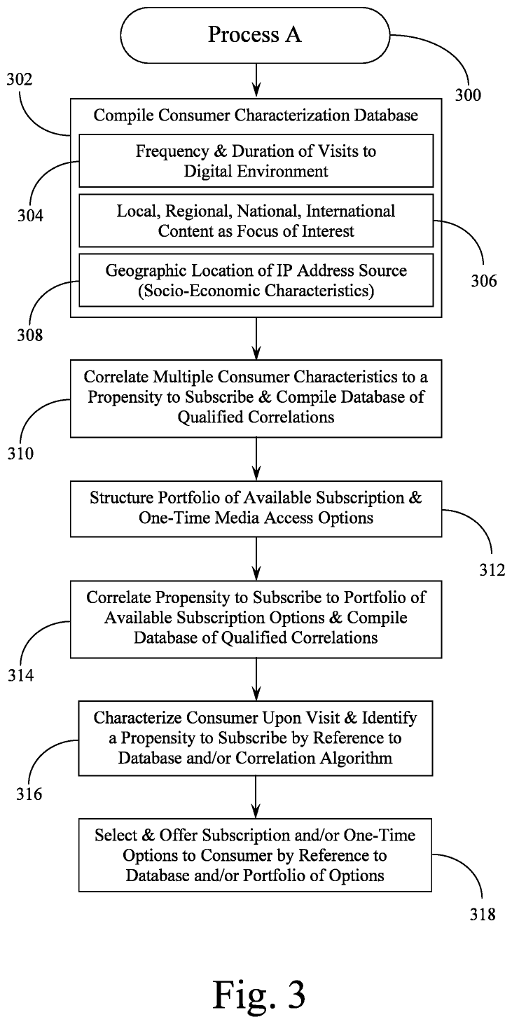

Reference is next made to FIG. 3 is a more detailed flowchart of the methodology broadly identified as Process A in the high-level flowchart shown in FIG. 1. Process A begins at Step 302 with the compilation of the consumer characterization database. This process involves the collection, organization, and prioritizing of large amounts of information, both historical and real time. Step 304 involves the collection of information on the frequency and duration of visits to the digital environment. Step 306 involves the identification of local, regional, national, and/or international content as a focus of interest. Step 308 involves the collection of information on geographic location (based on IP address source as well as other sources). To an extent, the geographic information assists in building socio-economic characteristics that play a part in characterizing the consumer. It is relevant at this point in the discussion to identify limits placed on the operation of the system and method of the present invention by online privacy laws, rules, and regulations. While the “resolution” of the analysis of the present invention may be theoretically unlimited, constraints on the availability of certain types of information and/or on the use of such information, will have a limiting effect on the level of detail that the system is permitted to operate at. While certainly a limitation, the privacy walls involving ever more detailed personal data do not inhibit the functionality of the present invention to the extent that most businesses are able to optimize margins with a relatively coarse (non-specific) view of their customers.

Process A then proceeds from compiling the database to correlating multiple consumer characteristics to a propensity to subscribe at Step 310. A further database of qualified correlations may then be compiled. This is followed by structuring a portfolio of available subscription and one-time media access options at Step 312. As indicated above, the compilation of the various databases involved in the methods of the present invention preferably occurs in a coordinated manner rather than in a “one before the other” manner. Consumer characteristics bear upon the portfolio of options and the portfolio of available options helps determine the emphasized consumer characteristics.

Process A continues in FIG. 3 with Step 314 involving the correlation of a propensity to subscribe with the portfolio of available subscription options and the qualified correlations established. Step 316 involves the actual identification (characterization) of the consumer at the time of a “visit” to the media environment and the identification of a propensity to subscribe by reference to the databases and/or the correlation algorithms. Finally, at Step 318, the process concludes with the selection and offering of a subscription option and/or a one-time purchase option to the consumer with direct reference to the mentioned databases and the portfolio of validated consumer experience options.

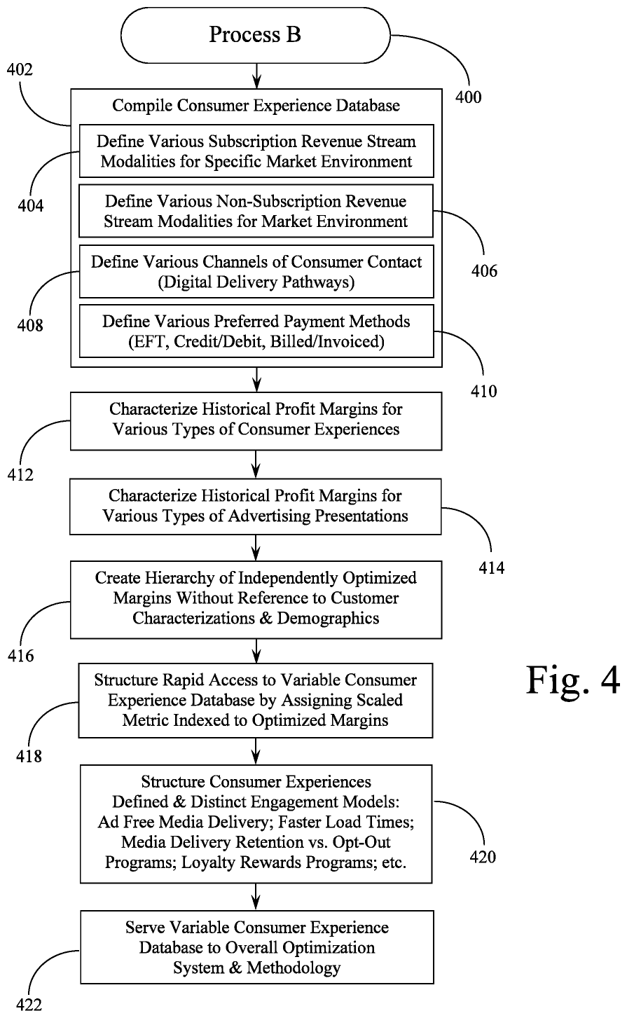

Reference is next made to FIG. 4 which is a more detailed flowchart of the methodology broadly identified as Process B in the high-level flowchart shown in FIG. 1. Process B begins with the compilation of the consumer experience database generally at Step 402. This involves defining various subscription revenue stream modalities for specific market environments at Step 404, defining various non-subscription revenue stream modalities for specific market environments at Step 406, defining various channels of consumer contact (digital delivery pathways) at Step 408, and defining various preferred payment methods (EFT, credit/debit, billed/invoiced, etc.) at Step 410.

Process B then progresses through a number of analysis and weighting steps to make the database readily correlated with the additional databases within the system. Step 412 involves characterizing historical profit margins for various types of consumer experiences. Step 414 involves characterizing historical profit margins for various types of advertising presentations. Step 416 involves creating a hierarchy of independently optimized margins without reference to customer characterizations and demographics. Step 418 involves system architecture structuring to provide rapid access to the variable consumer experience database by assigning scaled metrics indexed to optimized margins. The core of the process then occurs at Step 420 wherein the consumer experiences are structured as defined and distinct engagement models. Examples from the publishing industry include: ad free media delivery; faster load times; media delivery retention versus opt-out (or opt-in) programs; loyalty rewards programs; etc. Process B concludes with Step 422 where the system actually serves up the variable consumer experience database to the overall optimization system and method.

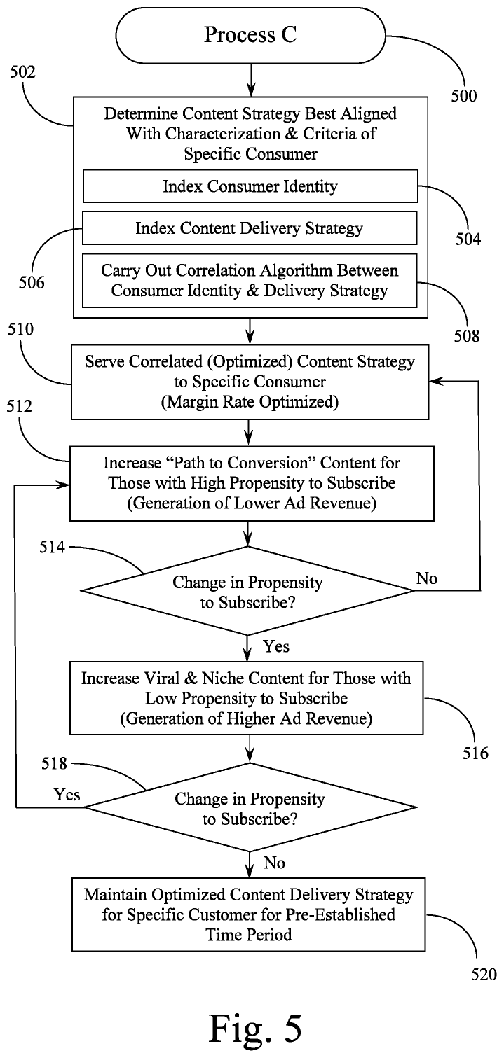

Reference is finally made to FIG. 5 which is a more detailed flowchart of the methodology broadly identified as Process C in the high-level flowchart shown in FIG. 1. Process C is initiated at Step 502 with a determination of the content strategy best aligned with the characterization and the criteria of the specific consumer. This involves the indexing of the consumer identity at Step 504, the indexing of the content delivery strategy at Step 506, and carrying out the correlation algorithm between the consumer identity and the delivery strategy at Step 508.

At Step 510, the correlated (optimized) content strategy is served to the specific consumer in a manner that achieves margin rate optimization for the business and the best available experience for the consumer. Since the process is dynamic, Step 512 involves the process of increasing “path to conversion” content for those with a high propensity to subscribe which would naturally result in lower ad revenue. Decision Step 514 measures and determines if there is a change in the propensity to subscribe (for any reason) and directs continued serving of the correlated content strategy if no change, and a possible increase in viral and niche content at Step 516 for those with a change to a low propensity to subscribe. Decision Step 518 continues the monitoring of the consumer propensity to subscribe and may yet again alter the balance between subscription and per-view revenue streams. Where no significant change occurs in the propensity to subscribe the system may preferably maintain the optimized content delivery strategy for the specific customer for an indefinite or a pre-established time period as shown in Step 520.

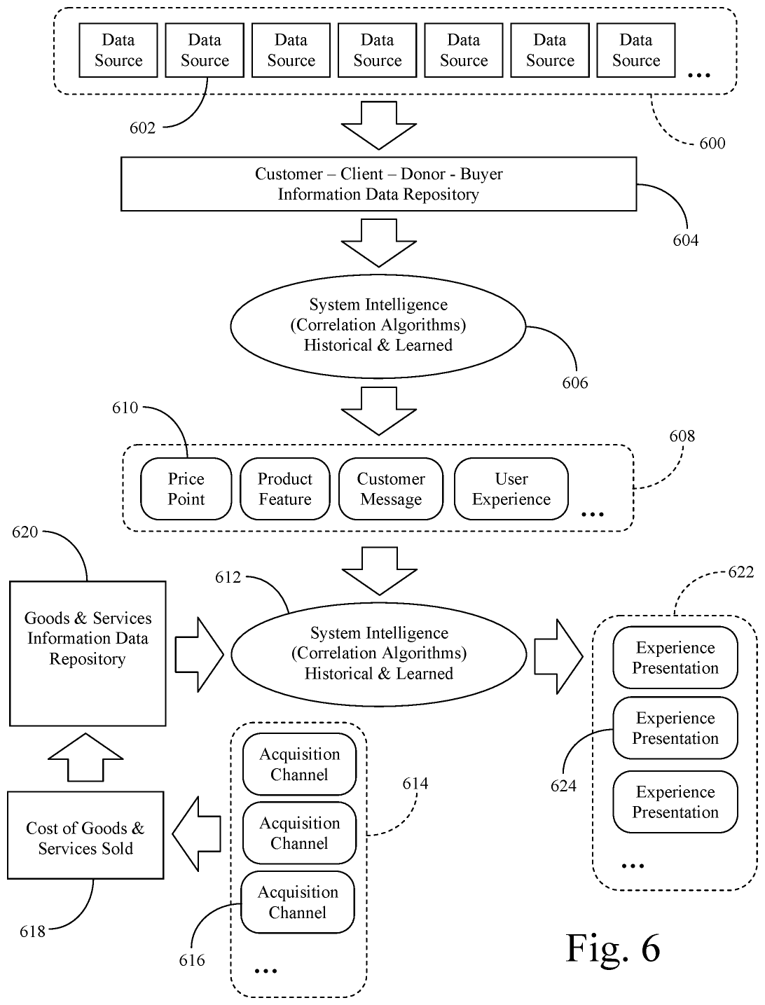

FIG. 6 provides a system overview to put each of the above described methods into perspective in the overall operational environment. The margin rate optimization system within an online purchasing environment provides a manner of identifying and structuring a propensity to purchase. Bringing analyzed data together from two directions, the overall process results in a customized user experience that optimizes margins for variable products and services.

Individual data sources 602 make up the limitless input from the direction of the purchasing public 600. This data is gathered into a single customer/client/donor/buyer information repository 604. The system intelligence 606 provides the correlation algorithms, both programmed and learned over time, to begin the process of identifying a propensity to purchase. This system intelligence acts on the portfolio 608 of variable elements 610 that are available to be modified to be presented to the user/customer. These variable elements 610 include such things as price point, product features, customer messages, and other elements in the user experience.

The portfolio 608 is then utilized as the source material for a further portion of the system intelligence 612 made up of correlation algorithms (again, historical and learned) that will eventually construct the “best” presented experience. A range of acquisition channels 616 (means for approaching a particular user) have been booked into a library 614 based on the particular industry or field of application. The cost of goods and services sold 618 are identified for each of the acquisition channels 616 and stored in a goods and services informational data repository 620 to be accessible to the system intelligence 612.

The result is the portfolio 622 of different experience presentations 624 that are calculated to optimize the margin rate across the variety of channels available and across the wide variety of users/customers that are encountered. In FIG. 6, the ellipses in each identified portfolio or collection represent the unlimited number of additional components within the respective portfolio that may be available depending on the industry or field of use.

Although the present invention has been described in conjunction with a number of preferred embodiments, those skilled in the art will recognize modifications to these embodiments that still fall within the spirit and scope of the invention. As indicated above, this detailed description uses the publishing industry as an example of a business model structured in a manner conducive to implementation of the systems and methods of the present invention. Almost any business, however, with a range of goods and services and/or a range of product delivery mechanisms, could benefit from the application of the present invention.

I claim:

1. A method for margin rate optimization, especially within an online purchasing environment, the method comprising the steps of:
identifying a customer's “propensity to purchase” a product or service of a particular type, the step of identifying comprising the steps of:
(a) collecting real time information on the customer through acquired online identification data;
(b) referencing historically collected information on the customer through stored data and search protocols through online available databases;
(c) constructing an information data repository of the collected customer information;
(d) carrying out a series of correlation algorithms on the collected customer information to score a customer's propensity to purchase through a portfolio of customer presentation elements; and
structuring a specific “customer experience” for the individual that maximizes margins for the goods and services and for the modes of product delivery; the step of structuring comprising the steps of:
(a) defining a portfolio of acquisition channels (modes) specific to the industry or field of application;
(b) quantifying a cost of goods and services sold for each defined acquisition channel (mode);
(c) constructing an information data repository of the goods and services characteristic, costs, and channels of trade information;
(d) carrying out a series of correlation algorithms on the identified customer “propensity to purchase” with the goods and service informational data to select a specific customer presentation experience from a portfolio of experience presentation; and
presenting the specific customer presentation to the customer user.
